(19) United States
(12) Patent Application Publication
(10) Pub. No.: US 2019/0147384 A1
(43) Pub. Date: May 16, 2019

(54) SKILL-SPECIFIC CONTRIBUTOR RATING SYSTEM

(71) Applicant: ADOBE SYSTEMS INCORPORATED, San Jose, CA (US)

(72) Inventors: Natwar Modani, Bangaluru (KA) (IN); Kundan Krishna, Bangaluru (KA) (IN); Harsh Khetan, Kharagpur (WB) (IN); Manoj Kilaru, Mumbai (MH) (IN)

(21) Appl. No.: 15/815,456

(22) Filed: Nov. 16, 2017

(51) Int. Cl. G06Q 10/06; G06Q 50/00

(52) U.S. Cl. CPC G06Q 10/06393; G06Q 30/0282; G06Q 50/01

(57) ABSTRACT

Embodiments of the present invention provide systems, methods, and computer storage media are generally directed to facilitating generation of contributor ratings. In one embodiment, upon obtaining content contributed by a contributor, a particular skill(s) associated with the contributed content is identified. An event-level rating indicating a value of the contributed content in relation to the particular skill can be determined based on, for example, context and sentiment associated with the contributed content. Such an event-level rating, among others, can be used to generate a contributor rating for the particular skill. The contributor rating for the particular skill can then be provided, for example, for presentation in association with the content contributed by the contributor.

### BACKGROUND

Social networking platforms oftentimes include a forum, or online discussion board, in which individuals can post content that is presented to other individuals or members of the online forum. In many cases, a viewer of the posted content may be interested in understanding the value or level of trust that can be assumed in association with the content posted by a contributor. To this end, some social networking platforms provide an indication of rank or rating associated with a contributor. For example, a score or badge may be provided to indicate value associated with a contributor of content.

In conventional systems, to determine a rank associated with a contributor, a length of the post can be measured and used as a basis for the ranking. To this end, a contributor providing a more lengthy post may be associated with a higher rank than a contributor providing a more brief post, irrespective of the quality or content of the post. Further, in conventional systems, a contributor is often associated with a single rank for any of their contributed content, irrespective of the subject matter to which the content is related. Accordingly, a ranking associated with the contributor may be misleading or inaccurate for a particular post of interest to a viewer. Unfortunately, a misleading or inaccurate ranking corresponding with a contributor may result in reliance on an answer provided by a contributor, which can result in a viewer taking an action or making a decision the viewer would not otherwise perform.

### SUMMARY

Embodiments of the present invention relate to methods, systems, and computer readable media for facilitating generation of skill-specific contributor ratings. That is, contributor ratings are determined for a contributor in association with a specific skill for which the contributor provided content. To generate skill-specific contributor ratings, embodiments of the present invention determine event-level ratings for individual content contributions, or content contribution events, in association with a set of skills conveyed in the content contribution. In particular, a content contribution can be analyzed to identify a set of skills corresponding with the content contribution. An event-level rating can then be generated or determined for each identified skill. In embodiments, each event-level rating for each skill can be determined using an outcome score, a context score, and a sentiment score. Upon generating the event-level rating for a particular skill, the event-level rating can be aggregated with other event-level ratings corresponding with the same skill to generate a contributor rating for the contributor.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a schematic depiction of a system for facilitating contributor rating identification, in accordance with embodiments of the present invention;

FIG. 2 is a depiction of a contributor rating engine, in accordance with embodiments of the present invention;

FIG. 3 is a user interface display showing contributed content and corresponding contributor ratings, in accordance with embodiments of the present invention;

FIG. 4 is a user display interface illustrating contributor ratings according to an example embodiment;

FIG. 5 is a flow diagram showing a method for facilitating contributor rating identification, in accordance with an embodiment of the present invention;

FIG. 6 is a flow diagram showing another method for facilitating contributor rating identification, in accordance with an embodiment of the present invention;

FIG. 7 is a flow diagram showing another method for facilitating contributor rating identification, in accordance with an embodiment of the present invention; and

FIG. 8 is a block diagram of an exemplary computing environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Many social networking platforms encourage users to contribute content. An individual or entity providing content is generally referred to herein as a contributor. One example of a social networking platform that obtains content from a contributor is a question-and-answer platform that enables a user to ask a question and receive answers from other users (contributors) in the social networking community. Exemplary question-and-answer platforms include Quora® and Stack Overflow®.

A contributor may be associated with a rating or score to indicate a value of his or her past contribution. Such a contributor rating can enable users viewing the content to understand the value of the contributions from the contributor in the past. For example, assume an individual asks a question via a question-and-answer social networking platform, and a contributor provides an answer to the question. Content provided by a contributor associated with a high rating may be deemed as reliable by a viewer, whereas content provided by a contributor associated with a low rating may be deemed unreliable by a viewer. Further, such contributor ratings may provide insight as to which contributors generally provide high value content and which contributors generally provide low value content. Such insight can be valuable, for example, to a marketer as the contributor rating associated with the contributor can impact marketing actions (e.g., selection of target advertisements).

Conventional approaches for scoring or rating contributors generally rely on a length of the content provided by a contributor. For instance, a contributor that provides a lengthy answer to a question will receive a higher score than a contributor that provides a brief answer to a question. Length of an answer, however, does not take into account the proficiency of the contributor or progress toward a desired outcome, among other things. For example, assume a user provides a superfluous answer to a question that covers the same content as a previously provided brief answer. In such a case, providing a higher score for the superfluous answer as compared to a lower score for the prior, but brief, answer can result in scores that do not accurately reflect the value provided by the respective contributors.

Further, with conventional systems, a rating is generally associated with a contributor irrespective of the topic of the content. That is, given rankings are universal across all topics of discussion. A general rating for a contributor, however, may be inaccurate for a particular topic of content provided by the contributor. For example, assume a contributor typically responds to technology questions with lengthy responses. In such a case, the contributor may have a high contribution rating. Now assume the contributor provides a response to a medical question. In such a case, despite the lack of previous responses in association with medical questions, the high contributor rating may be presented in association with the contributor's response to the medical question. Such a high contributor score associated with the contributor's response to the medical question may be misleading and result in a viewer overvaluing the response. As such, an overall, or general, score for a contributor may not be as insightful as desired for particular contributions (e.g., answers to questions).

Accordingly, embodiments of the present invention relate to methods, systems, and computer readable media for facilitating generation of skill-specific contributor ratings. A skill-specific contributor rating provides an indication of value of content provided by a contributor in relation to a specific skill. As described herein, a skill generally refers to a topic or subject matter. In this regard, a first contributor rating associated with one skill (e.g., technical) may be determined for a contributor, and a second contributor rating associated with another skill (e.g., medical) may be determined for the contributor. Advantageously, generating different contributor ratings for different skills provides a more accurate or insightful reflection of the value of content provided by the contributor.

Further, contributor ratings can be generated based on multiple facets of the content contribution. For example, as described herein, a contributor rating may be based on outcome scores, context scores, and sentiment scores associated with the content contribution. An outcome score generally refers to an objective measure associated with a content contribution. A context score generally refers to a measure or extent of importance of a content contribution in a given context. In embodiments, the context score can indicate an extent of progress towards a desired outcome (e.g., new information) associated with the content contribution. A sentiment score generally refers to a measurement or extent of how valued a content contribution is to others. As such, the sentiment feature indicates a proficiency of the contributor. Utilizing outcome features, context features, and sentiment features to value contribution content can result in a contributor rating that reflects the proficiency of the contributor as well as progress toward a desired outcome thereby providing a more meaningful representation of the content provided by a contributor.

In implementation, and at a high level, an event-level rating can be generated in association with a content contribution event for a set of skills corresponding with the content contribution event. In this regard, for each skill identified for the content contribution event, an event-level rating can be generated. As described herein, in embodiments, each event-level rating for a content contribution event can be based on outcome scores, context scores, and/or sentiment scores. By way of example only, assume that a content contribution event includes subject matter directed to a first skill and a second skill. In such a case, an event-level rating associated with the first skill can be generated using outcome scores, context scores, and/or sentiment scores, and an event-level rating associated with the second skill can be generated using outcome scores, context scores, and/or sentiment scores. As described in more detail below, the portion of the content specific to the first skill may be analyzed to identify outcome, content, and/or sentiment scores for the first skill, while the portion of the content specific to the second skill may be analyzed to identify outcome, content, and/or sentiment scores for the second skill.

Upon determining the event-level rating associated with a skill, the event-level rating can be aggregated with other event-level ratings for the same skill such that a contributor rating is generated for the skill. In this way, a contributor rating associated with a skill is generally based on various content contributions corresponding with that skill. A contributor may have any number of contributor ratings, depending on the number of skills associated with content provided by the contributor.

In some implementations, to generate contributor ratings associated with a skill, timing and/or confidence associated with content contribution events can be taken into account. To this end, more recent event-level ratings may have more impact on the contributor rating than less recent event-level ratings. Further, the more a contributor provides content related to a particular skill, the contributor rating can be associated with a greater confidence. For example, a contributor that has provided 100 content contributions in association with a particular skill would be deemed more valuable than a contributor that has provided one content contribution in association with the same skill.

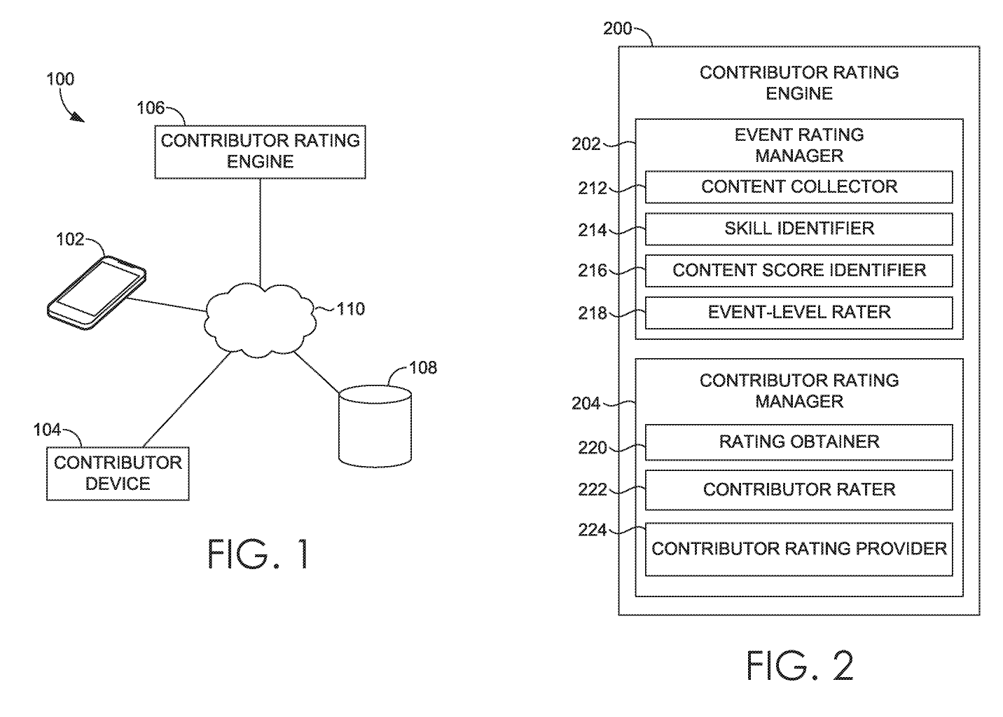

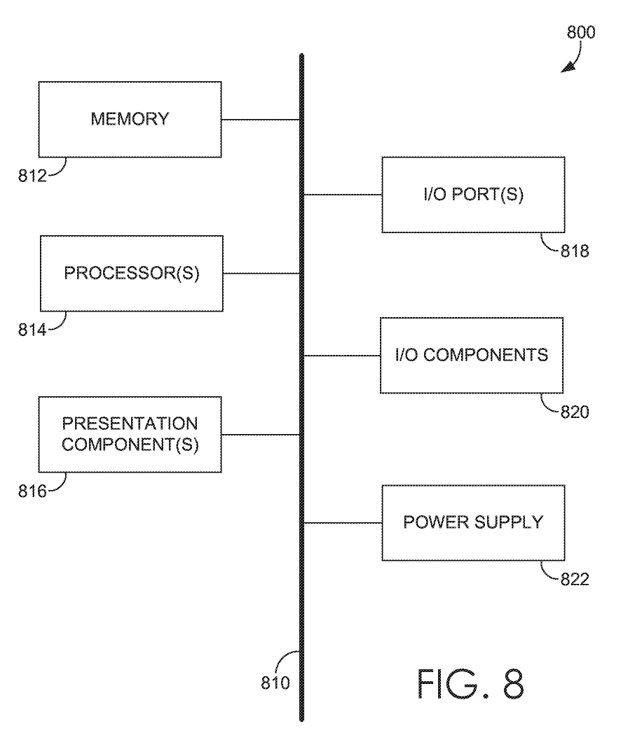

Turning now to FIG. 1, a schematic depiction is provided illustrating an exemplary system 100 in which some embodiments of the present invention may be employed. Among other components not shown, the environment 100 may include user device 102, contributor device 104, contributor rating engine 106, and a data store 108. It should be understood that the system 100 shown in FIG. 1 is an example of one suitable computing system. Any of the components shown in FIG. 1 may be implemented via any type of computing device, such as computing device 800 described with reference to FIG. 8, for example. The components may communicate with each other via one or more networks 110, which may include, without limitation, one or more local area networks (LANs) and/or wide area networks (WANs). Such networking environments are commonplace in offices, enterprise-wide computer networks, intranets, and the Internet.

It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Generally, system 100 facilitates generating skills-specific contributor ratings. As described, contributor ratings refer to an indication or measure of value of content provided by a contributor. In embodiments described herein, the contributor ratings can be associated with a specific skill. Accordingly, a viewer of the content can gauge the value or relevance of the content more accurately as the corresponding contributor rating is applicable or more relevant to the current content provided by the contributor.

At a high level, to generate skill-specific contributor ratings, content provided by the contributor is analyzed to identify or detect a set of relevant skills. For each identified skill, an event-level rating can be generated for a content contribution event based on content scores. For example, assume a first skill and a second skill are identified in association with a content contribution provided via a first event. In such a case, a first event-level rating can be generated for the first skill, and a second event-level rating can be generated for the second skill. As can be appreciated, various content scores can be determined and utilized to generate an event-level rating. For instance, an event-level rating may be generated based on an outcome scores, a context scores, and a sentiment scores. The event-level rating can then be aggregated with other event-level ratings corresponding with the same skill to generate a contributor rating associated with that specific skill.

With continued reference to FIG. 1, in operation, the user device 102 and contributor device 104 can access the contributor rating engine 106 over a network 110 (e.g., a LAN or the Internet). For instance, the user device 102 and contributor device 104 may provide and/or receive data from the contributor rating engine 106 via the network 110. Network 110 may include multiple networks, or a network of networks, but is shown in simple form so as not to obscure aspects of the present disclosure. By way of example, network 110 can include one or more wide area networks (WANs), one or more local area networks (LANs), one or more public networks, such as the Internet, and/or one or more private networks. Networking environments are commonplace in offices, enterprise-wide computer networks, intranets, and the Internet. Accordingly, network 110 is not described in significant detail.

A user device, such as user device 102, may be any computing device that is capable of receiving content and/or presenting content to a user, for example, via a web browser or application installed thereon. In particular, and in accordance with embodiments described herein, user device 102 can receive input from a user soliciting contributions from a contributor. For example, a user may input a question via a question-and-answer platform to solicit answers from other users of the question-and-answer platform. Although social networking platforms are generally described herein with reference to a question-and-answer platform, such an implementation is not required. For example, a contributor may input content via a contributor device unprompted by a question, for example, within a social networking platform such as Twitter.

The input (e.g., question) provided by a user may be presented to the user via the user device 102, for instance by way of a web browser or application. In addition to a question input, the user device can present content contributions provided by any number of contributors. For instance, assume a user posts a question via the user device. Further assume that three contributors provide an answer to the question. In such a case, the question and the answers provided by the contributors can be displayed to the user via the user device. As can be appreciated, although only one user device is presented, any number of user devices can input and/or present content. For example, many user devices may present the question and corresponding answers such that the question and answers are presented to various members of a social networking platform.

In accordance with embodiments of the present invention, in addition to presenting a content contribution, an indication of the contributor rating can also be presented. In this regard, in association with presenting content contributions (e.g., answers provided by contributors), an indication or identification of the contributor as well as a corresponding contributor rating may be presented. The contributor rating can be presented or represented in any number of ways. For example, a numerical score, a numerical ranking, a color coding, an icon, text, an image, or the like may indicate a rating associated with a contributor.

As skill-specific contributor ratings can be generated in association with various skills, the rating that is applicable to the specific skill can be presented. In some embodiments, multiple contributor ratings might be presented. For example, assume a contributor provides an answer to a question. Further assume that a contributor is associated with a first contributor rating for a first skill, a second contributor rating for a second skill, and a third contributor rating for a third skill. In such a case, each of the first contributor rating, second contributor rating, and third contributor rating (and corresponding skills) might be presented in association with an identification of the contributor providing the content. As another example, a viewer may be able to select an identification of the contributor or corresponding content, and thereafter, be presented with the first, second, and third ratings (and corresponding skills). In other embodiments, a contributor rating(s) identified as specific to the contribution content may be presented. In this regard, the content provided by the contributor may be analyzed to identify a set of related skills. For each skill identified as relevant to the particular contribution content, the corresponding contributor ratings can be presented. In this regard, rather than providing contributor ratings for all skills related to a contributor, only the contributor rating(s) related to the particular content may be presented.

The user device 102 may be operated by any user to view content, such as content provided by various contributors. While only one user device 104 is illustrated in FIG. 1, multiple user devices associated with any number of users may be utilized to carry out embodiments described herein. The user device 102 may take on a variety of forms, such as a personal computer (PC), a laptop computer, a mobile phone, a tablet computer, a wearable computer, a personal digital assistant (PDA), an MP3 player, a global positioning system (GPS) device, a video player, a digital video recorder (DVR), a cable box, a set-top box, a handheld communications device, a smart phone, a smart watch, a workstation, any combination of these delineated devices, or any other suitable device. Further, the user device 102 may include one or more processors, and one or more computer-readable media. The computer-readable media may include computer-readable instructions executable by the one or more processors.

A contributor device, such as contributor device 104, may be any computing device that is capable of facilitating a contributor to provide content. In this regard, continuing with the example of a question-and-answer platform, a contributor device may be operated by an individual or entity that provides an answer or response to a question. Such contributed content can be analyzed to identify a contributor rating associated with the contributor providing the content.

The contributor device 104 may be operated by any user or contributor that provides content. For example, a user may provide content to the contributor rating engine 106 via a browser or application installed on the contributor device 104. Any type of user interface may be used to provide such content. In some cases, a user may input the content, for example, by typing or copying/pasting content. In other cases, content may be input by providing or inputting a reference to such content (e.g., a link, a URL, or pointer to content).

In some cases, the contributor device 104 accesses the contributor rating engine 106 via a web browser, terminal, or standalone PC application operable on the user device. While only one contributor device 104 is illustrated in FIG. 1, multiple contributor devices associated with any number of contributors may be utilized to carry out embodiments described herein. The contributor device 104 may take on a variety of forms, such as a personal computer (PC), a laptop computer, a mobile phone, a tablet computer, a wearable computer, a personal digital assistant (PDA), an MP3 player, a global positioning system (GPS) device, a video player, a digital video recorder (DVR), a cable box, a set-top box, a handheld communications device, a smart phone, a smart watch, a workstation, any combination of these delineated devices, or any other suitable device. Further, the contributor device 104 may include one or more processors, and one or more computer-readable media. The computer-readable media may include computer-readable instructions executable by the one or more processors.

The data store 108 includes data used to facilitate contributor rating identification. As described in more detail below, the data store 108 may include content data, such as content contributions and/or metadata associated therewith, responses to content contributions, content scores, and/or contributor ratings. Such data may be stored in the data store 108 and accessible to any component of the system 100. The data may also be updated at any time. In embodiments, the content contributions are updated dynamically or, in real-time, for example as content contribution is provided or at any point when data changes.

The contributor rating engine 106 is generally configured to generate contributor ratings and, in particular, skill-specific contributor ratings. At a high-level, the contributor rating engine 106 generates contributor ratings using content features identified in association with content contributions. In particular, the contributor rating engine 106 can obtain and analyze contributed content to identify one or more skills associated therewith. In embodiments, outcome scores, context scores, and sentiment scores are determined in association with contributed content, and in particular contributed content events. The contributor rating engine 106 can then utilize the content scores to determine a contributor rating for a contributor. In particular, skill-specific contributor ratings can be determined to specify a rating corresponding to a particular skill.

An exemplary contributor rating engine is provided in FIG. 2. As shown in FIG. 2, a contributor rating engine 200 includes an event rating manager 202 and a contributor rating manager 204. The event rating manager 202 generally facilitates generating an event-level rating(s) for a particular event, and the contributor rating manager 204 utilizes a set of event-level rating(s) to generate a rating for the contributor. As described herein, the event-level ratings as well as the contributor rating can correspond with a specific skill. That is, event-level ratings and contributor ratings may be determined for specific skills in association with a contributor.

Although illustrated as separate components of the contributor rating engine 200, any number of components can be used to perform the functionality described herein. Further, although illustrated as being a part of a contributor rating engine, the components can be distributed via any number of devices. For example, an event rating manager can be provided via one device, server, or cluster of servers, while the contributor rating manager can be provided via another device, server, or cluster of servers. The components identified herein are merely set out as examples to simplify or clarify the discussion of functionality. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more components may be carried out by hardware, firmware, and/or software. For instance, various functions may be carried out by a processor executing instructions stored in memory.

Further, as can be appreciated, in some embodiments, the contributor rating engine 200 may be incorporated within a social networking platform to identify contributor ratings for contributors to the social network platform. In other embodiments, the contributor rating engine may be in communication with a social networking platform to identify contributor ratings for contributors and provide such contributor ratings to the social networking platform. The social networking platform can then provide and present such contributor rankings as desired, for example, via the user device 102 and contributor device 104 of FIG. 1. In this regard, the user device 102 and contributor devices 104 of FIG. 1 may communicate directly with the social networking platform, which in turn can communicate with the contributor rating engine.

As described, the event rating manager 202 is generally configured to generate event-level ratings associated with content contributions. An event-level rating generally refers to a rating associated with a particular content contribution or content contribution event. An event rating manager 202 may include a content collector 212, a skill identifier 214, a content score identifier 216, and an event-level rater 218. Although illustrated as separate components of the event rating manager 202, any number of components can be used to perform the functionality described herein.

The content collector 212 is configured to collect or obtain content. In particular, the content collector 110 collects content associated with content contribution events. As described, content refers to content, typically textual content, from which contributor ratings can be generated. A content contribution event can be content from a single post by a contributor, such as a post including information answering a question.

Content can be collected or obtained in any manner. In some cases, content is provided by a contributor of a social networking platform. In this regard, a contributor might enter or input content, for example, via a social networking website accessible by way of a browser or an application. As an example, a user might enter or select content via user device 104 of FIG. 1 that is connected to the network 110. Such contributed content (e.g., answers or responses to posed questions) may then be directly provided to the contributor rating engine 200 (e.g., content collector 212). Alternatively or additionally, the contributed content may be communicated to a social networking platform (e.g., a web server separate from the contributor rating engine) that can then provide the content to the contributor rating engine 200. In some cases, a web crawler may be used to collect content, such as content from websites or web pages. In this regard, the content collector 212 can crawl, or utilize a web crawler to crawl, various sources to identify content that can be used in generating contributor ratings. The identified content can be stored, for example, in a data store (e.g., data store 108 of FIG. 1).

A skill identifier 214 is generally configured to identify a set of skills associated with content contributions. In this regard, for a particular content contribution event, any number of skills associated with the content can be identified. As described, a skill can refer to a topic or subject matter corresponding with the content contribution. By way of example only, assume a content contribution event discusses two separate skills. In such a case, the content can be analyzed to identify the first skill and the second skill.

Skills can be identified in any number of ways, some of which are described herein. As one example to identify skills, a contributor providing the content can specify skills related to the content. For instance, a contributor providing content related to travel planning may select hotel selection and car rentals as applicable skills when the contributor provides content suggesting a hotel and car rental location.

As another example, a content contribution event can be analyzed in an automated manner (e.g., without user interaction) to automatically identify applicable skills. In such a case, a domain-specific lexicon (e.g., stored in a data store) can be used to identify a set of skills. By way of example only, for a technical domain, terms or phrases can be identified that are related to various technical categories, such as machine learning, computational geometry, etc. As another example, and continuing with the travel example discussed above, assume a contributor provides content related to suggested hotels and car rental locations. In such a case, based on identification of the term “hotel” and “car rental,” a travel planning skill may be identified and, even more particularly, in some cases, hotel planning and car rental planning skills may be identified. A lexicon, or domain-specific lexicon, can be created manually or automatically, for instance. A lexicon can be created automatically via automated algorithms that leverage domain knowledge.

In one implementation, a skill can be identified based on an occurrence(s) of a word(s) from a given category of a domain. In this regard, a term-frequency based approach can be used. For instance, frequencies of different words occurring in a corpus of articles of a particular topic (e.g., politics) can be collected and used to create a frequency-based signature. Alternatively or additionally, a signature can be generated based on a manually curated list of words or terms relevant to each of a plurality of skills. In automated analyzing of the contributed content, word frequencies can be determined and compared with signatures associated with various skills to identify the best-matched skill for the contributed content.

In another implementation, topic models, such as Latent Dirichlet Allocation (LDA), can be used to identify a topic(s) associated with content. For example, LDA can be used to identify whether an answer provided via a social networking platform relates to politics or science. Such models can be automatically trained in an unsupervised manner.

The content score identifier 216 is generally configured to identify or determine content scores associated with contributed content. In this regard, upon obtaining or referencing content, the content may be analyzed to identify content scores. A content score refers to any measure or extent of value associated with a content contribution event. Content scores may include, but are not limited to, outcome scores, context scores, and sentiment scores. As can be appreciated, any type of scores indicating content value can be used herein.

An outcome score generally refers to an objective measure associated with a content contribution. In embodiments, the outcome score provides an objective measurement of execution of a content contribution in association with a skill. By way of example only, an outcome score may be determined based on a length of a content contribution (e.g., number of words, number of characters, etc.), a number of responses or comments associated with a content contribution (e.g., a number of “likes” or “dislikes” or upvotes, etc.), and/or the like. In embodiments, a greater length or greater number of responses might result in a greater outcome score. For example, a content contribution that results in a large number of “likes” (e.g., that exceeds a threshold value) may have a higher outcome score than a content contribution that results in a small number of “likes.”

A context score generally refers to a measure or extent of importance of a content contribution in a given context. In embodiments, the context feature can indicate an extent of progress (e.g., new information) towards a desired outcome or objective (e.g., information pertaining to travel itineraries) associated with the content contribution. In this regard, a context score can capture the extent to which a content contribution advances an overall purpose of a discussion or question. For example, a context score may be based on an amount of new information provided, an amount of alternative or different information provided, or the like. Accordingly, information provided by a content contributor already conveyed by another content contributor may be deemed as less valuable in terms of moving towards the objective of the original question or post.

One approach to identifying an extent to which a content contribution advances an objective or progresses toward an objective utilizes a response(s) to the content contribution. For example, a user posing a question may provide a response as to how close the question is to being answered via a content contribution. In such a case, the user may provide a rank or value, or simply indicate the contributed content adds value in advancing the objective (e.g., the content is new, informative, an alternative approach, etc.).

In another approach to identify an extent to which a content contribution advances an objective, a difference between the extent to which the question has been answered before a given post as compared to the extent to which the question is answered in accordance with the given post can be determined. Such a difference can indicate a contextual contribution of this post towards achieving the objective. By way of example only, assume a given question requests suggestions for a travel itinerary to a particular destination. An answer that presents an itinerary that is very different from the itineraries already present in other answers goes further in achieving the purpose of the question. As another example, a new answer that proposes an alternative way of solving a problem can be identified as more valuable than an answer that proposes a previously described method for solving a problem.

To measure how different a new answer is from a previous set of answers, a distance between a new answer and each existing answer can be measured. In some implementations, a TF-IDF vector-based cosine distance can be used to measure such a difference. In other implementations, an embedding-based technique, such as doc2Vec, can be utilized to measure such a difference. Upon determining a distance (e.g., via a TF-IDF vector-based cosine distance or an embedding-based technique), a minimum of the distances (e.g., dmin) from a content contribution to each of other contributed content (e.g., other previously provided contributed content or each existing answer) can be determined. The context score can then be determined as the inverse of the minimum distance (e.g., 1/dmin).

The sentiment score refers to a measure or extent indicating how well the particular skill has been performed or executed (quality of solution). To this end, a sentiment score can indicate the ease of understanding the contribution content, whether the contribution content is supported by data, or some other factor indicating trust of content. Generally, the sentiment feature can be determined from responses to contribution content. For example, responses or comments provided in response to the contribution content can be analyzed. Such responses may be from the user that posted an original question or from other users or viewers of a social networking platform. For example, in an online social platform, the sentiments in the comments of the other users on the site can be analyzed about the posts for a particular contributor. In this way, the content of comments are analyzed to determine a sentiment score.

By way of example only, assume a user comments “Wow! That's a wonderful itinerary” in response to a contributor content. In such a case, upon analyzing the comment, the sentiment score may be a high score. As another example, a comment like “Thanks! Your solution worked for me” may be associated with a high sentiment score, while “Nope. Didn't work” may be associated with a low sentiment score. As can be appreciated, the sentiment score can be based on any number of comments or responses associated with a contribution content.

In some cases, the content scores, such as context score may be positive and/or negative scores. By way of example only, a context score may be positive when the content contribution advance towards the objective. On the other hand, the context score may be negative when the content contribution does not advance toward, or it moves away from, the objective, for example, when a contributor posts an answer that contradicts a correct answer or provides confusion.

In some embodiments, one or more of the content scores can be determined based on the particular portion of the contribution content that is specific to a skill. For example, in determining the length of a contribution content for an outcome score, a length of the portion of the content specific to a first skill may be used as a content score for the first skill, while the length of the portion of the content specific to a second skill may be used as a content score for the second skill. As another example, in determining a difference between content contributions for a context score, the difference may be specific to portions of the content contributions associated with a same skill (e.g., hotel recommendations). In such embodiments, a portion of the contribution content specific to a skill can be automatically identified by a processor and, in some cases, a portion of a question, other contribution content, and/or comments/response specific to the same skill may also be identified such that appropriate content can be analyzed in relation to a specific skill. To this end, content may be automatically analyzed to parse the content in association with a specific skill. For instance, a first portion of a content may be automatically identified as corresponding to a first skill, while a second portion of the content may be automatically identified as corresponding to a second skill.

Upon identifying content scores, the event-level rater 218 can identify event-level ratings. In particular, the event-level rater can identify event-level ratings for each identified skill associated with the content contribution event (in an automated manner). In embodiments, the event-level rating includes an aggregate of the content scores. By way of example, assume an outcome score, a context score, and a sentiment score are identified for a content contribution event. In such a case, the scores can be aggregated to identify an event-level rating. As the event-level ratings are particular to skills, as can be appreciated, one event-level rating associated with one skill may be high, while another event-level rating associated with another skill may be low. For instance, assume a post related to a driving route and hotels is identified as being associated with two skills. Further assume that the contributor provides a more valued answer associated with the driving route than provided in association with hotels. In such a case, the event-level rating associated with the driving route skill may be high, while the event-level rating associated with the hotels may be low.

In some cases, a weighted average or weighted computation may be used to generate an event-level rating. In this regard, a weighted sum of content scores may be used to generate the event-level rating. The weights can be designated in association with each score to indicate how much emphasis is to be given to outcome, context, and sentiment scores. For example, if the weight is high for the outcome score, then the most up-voted answers might be rewarded more. As another example, if the weight for the context score is high, then novel answers that are different might be rewarded more. The weights applicable to each score may be provided in any number of ways, such as, for example, via a user, via a programmer, via an automated determination (e.g., using machine learning), or the like.

The event-level ratings associated with skills may be stored for subsequent utilization. Event-level ratings can be stored in any manner. In one embodiment, an event-level rating can be stored in association with the corresponding contributor and skill. Although generally described herein as using the event-level ratings to generate a rating for the contributor, as can be appreciated, in some embodiments, the event-level ratings can be provided for presentation to a user. For instance, assume a contributor provides content in response to a question. In such a case, an event-level rating can be generated in association with the particular contribution, and the event-level rating indicating the value of that specific contribution can be provided for presentation. Such event-level ratings can also be used to rank the order in which content is presented.

The contributor rating manager 204 generally utilizes a set of event-level rating(s) to generate a contributor rating for the contributor. As described herein, the contributor rating can correspond with a specific skill. That is, contributor ratings may be determined for specific skills in association with a contributor. A contributor rating manager 204 may include a rating obtainer 220, a contributor rater 222, and a contributor rating provider 224. Although illustrated as separate components of the contributor rating manager 204, any number of components can be used to perform the functionality described herein.

The rating obtainer 220 is configured to obtain event-level ratings for a contributor associated with a particular skill. In this manner, the rating obtainer 220 can obtain any number of event-level ratings that correspond to a particular skill for a contributor. By way of example only, assume a contributor provided contribution content associated with a first skill on five occasions. In such a case, the rating obtainer 220 can obtain event-level ratings associated with the first skill for each of those five contributions.

For each skill associated with a contributor, the contributor rater 222 can use the obtained event-level ratings and generate a contributor rating for the particular skill. The contributor rating can be determined in any number of ways. As one example, the aggregator rater 222 might average the various event-level ratings corresponding with a particular skill for a contributor. As another example, the aggregator 222 might take a median or mode of the various event-level ratings corresponding with the particular skill for a contributor to determine a contributor rating.

In other embodiments, event-level ratings might be weighted to determine a contributor rating. In one implementation, more recent content contribution events may be weighted higher than older content contribution events. Weighting event-level ratings based on date can enable a more equal opportunity for newer contributors to increase their contributor rating and thereby reduce an advantage for individuals that have been answering for a longer period of time. One example is to use an exponential decay with time for the older event-level ratings. Using exponential decay, a value can decrease at a rate proportional to its current value. For instance, with a half-life, after a particular number of days, the value will reduce to half of the current value. For example, assume an event-level rating of 100 has been determined and a 10 day half-life is selected. After 10 days, the rating value would reduce to 50 and, after another 10 days, the value would reduce to 25. As another example, the exponent can be selected in such a way that the scores from one-week old events have half the weight to the events today.

In determining contributor ratings, in some implementations, confidence can be utilized. By way of example only, if a contributor has answered 100 questions on a particular topic, a greater degree of confidence that the estimated skill level of the contributor is accurate can be assumed. On the other hand, if the contributor has answered one question on a particular topic, a lesser degree of confidence that the estimated skill level of the contributed is accurate can be assumed. Confidence can increase based on the square root of the number of observations. The confidence value can be used to scale the rating (i.e., by multiplying the skill rating with confidence), which becomes more robust, that is, a small change in the input data would not result in large change in the skill rating for the contributor.

The contributor rating provider 224 is configured to provide contributor ratings. In this regard, upon determining contributor ratings, the contributor ratings can be provided, for example, to a user device or another server, such as a social networking platform. In the event the contributor ratings are provided to a social networking platform, the social networking platform can store such ratings and provide to user devices as appropriate.

Contributor ratings can be presented in any number of ways. In accordance with embodiments described herein, contributor ratings can be presented in association with a content contribution. In this regard, based on content contributed by a contributor, a contributor rating can be presented in connection with the contributed content (e.g., adjacent to or nearby the contributed content). For example, in association with presenting content contributions (e.g., answers provided by contributors), an indication or identification of the contributor as well as a corresponding contributor rating may be presented. The contributor ratings can be represented using, for example, a numerical score, a numerical ranking, a color coding, an icon, text, an image, or the like.

As skill-specific contributor ratings can be generated in association with various skills, the rating that is applicable to a specific skill may be presented. In some embodiments, multiple contributor ratings might be presented. For example, assume a contributor provides an answer to a question. Further assume that a contributor is associated with a first contributor rating for a first skill, a second contributor rating for a second skill, and a third contributor rating for a third skill. In such a case, each of the first contributor rating, second contributor rating, and third contributor rating (and corresponding skills) might be presented in association with an identification of the contributor providing the content. As another example, a viewer may be able to select an identification of the contributor or corresponding content, and thereafter, be presented with the first, second, and third ratings (and corresponding skills). In other embodiments, a contributor rating(s) identified as specific to the contribution content may be presented. In this regard, the content provided by the contributor may be analyzed to identify a set of related skills. For each skill identified as relevant to the particular contribution content, the corresponding contributor ratings can be presented. In this regard, rather than providing contributor ratings for all skills related to a contributor, only the contributor rating(s) related to the particular content may be presented. In some embodiments, contributor ratings may also be used to determine a rank or order in which to present content. For example, content provided by a contributor with a higher rating may be presented above content provided by a contributor with a lower rating.

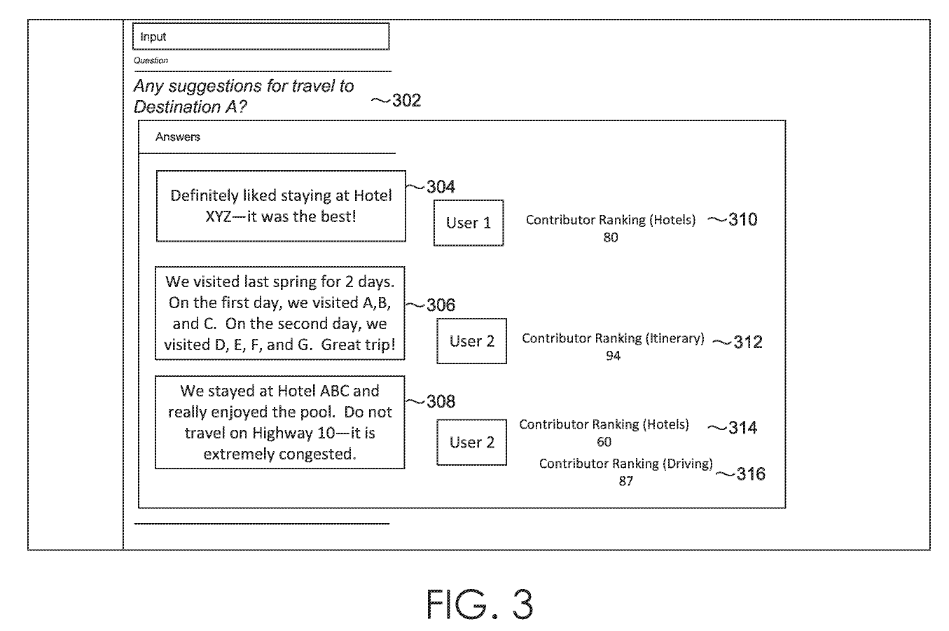

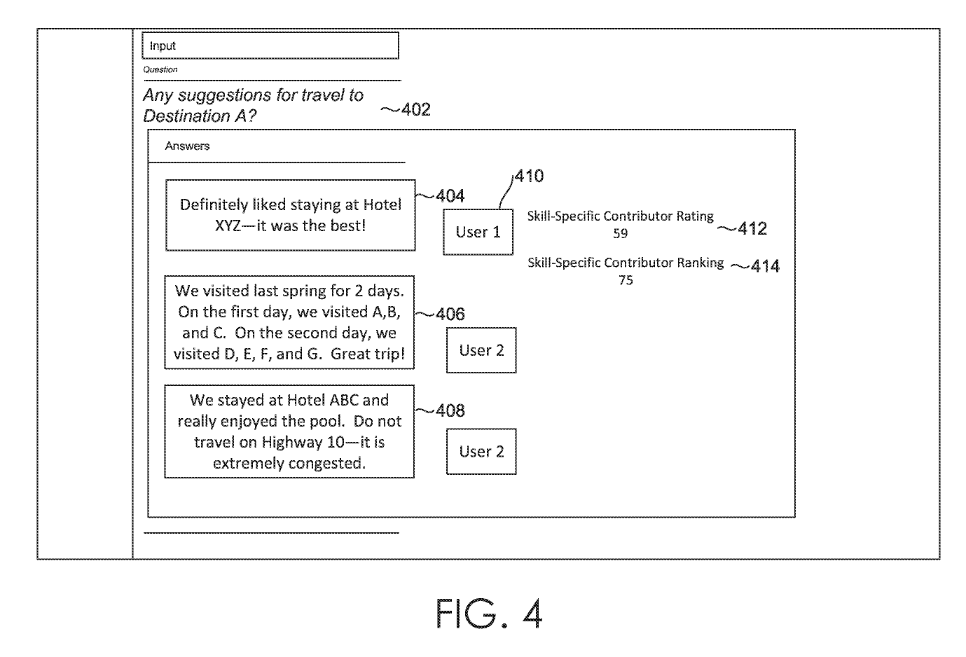

By way of example only, and with reference to FIGS. 3 and 4, user interfaces are provided in which contributor ratings can be provided. As shown in FIG. 3, a user may input a question 302 for which answers are desired. Upon inputting a question 302, other users of the social networking platform can provide content contributions, or answers, to the question 302. As shown in FIG. 3, assume a first contributor provides a first content contribution 304, a second contributor provides a second content contribution 306, and a third contributor provides a third content contribution 308. Assume that question 302 is soliciting answers regarding travel to a particular destination. Further assume that the first content contribution 304 provides information regarding hotels, the second content contribution 306 provides information regarding itineraries, and the third content contribution 308 provides information regarding driving routes and hotels. As shown in FIG. 3, each contributor providing the corresponding content contribution can be associated with a contributor rating(s). Each contributor rating is skill-specific such that the contributor rating reflects a rating corresponding with the specific skill, or topic, conveyed in the content contribution. In this regard, the first contributor is associated with a first contributor rating 310 that reflects a rating corresponding with a “hotel” skill, the second contributor is associated with a second contributor rating 312 that reflects a rating corresponding with the “itinerary” skill, and the third contributor is associated with a third contributor rating 314 that reflects a rating corresponding with the “driving” skill as well as a fourth contributor rating 316 that reflects a rating corresponding with the “hotels” skill. Although the contributor ratings are illustrated herein as numerals, as can be appreciated, such contributor ratings can be reflected via colors, badges, icons, text, etc.

As shown in FIG. 4, a user may input a question 402 for which answers are desired. Upon inputting a question 402, other users of the social networking platform can provide content contributions, or answers, to the question 402. As shown in FIG. 4, assume a first contributor provides a first content contribution 404, a second contributor provides a second content contribution 406, and a third contributor provides a third content contribution 408. Assume that question 402 is soliciting answers regarding travel to a particular destination. Further assume that the first content contribution 404 provides information regarding hotels, the second content contribution 406 provides information regarding itineraries, and the third content contribution 408 provides information regarding driving routes and hotels. Each contributor providing the corresponding content contribution can be associated with a contributor rating. In FIG. 4, such contributor ratings are not initially displayed. However, assume a user hovers over or selects one of the contributor identifiers, such as contributor identifier 410 corresponding with the first content contribution 404. Based on selection of the contributor identifier 410, a set of contributor ratings associated with the contributor can be presented. Such contributor ratings can be skill-specific contributor ratings. In this regard, a first skill-specific contributor rating 412 and a second skill-specific contributor rating 414 can be provided. In some cases, the skill-specific contributor ratings presented may be those specific to the content contribution 404. In other cases, the skill-specific contributor ratings present may correspond to any or all skills associated with the contributor. Although the contributor ratings are illustrated herein as numerals, as can be appreciated, such contributor ratings can be reflected via colors, badges, icons, text, etc.

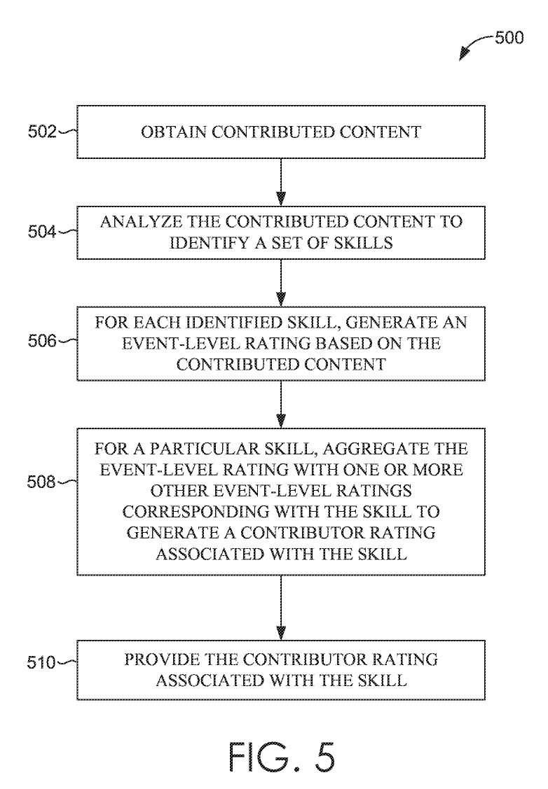

Turning now to FIG. 5, a flow chart is illustrated showing an exemplary method 500 of generating contributor ratings, in accordance with embodiments of the present invention. In embodiments, the method 500 is performed by a contributor rating engine, such as contributor rating engine 200 of FIG. 2. Initially, and as indicated at block 502, contributed content is obtained. For example, contributed content may be provided by a contributor in response to a question posted by another user of a social networking platform. At block 504, the contributed content is analyzed to identify a set of skills associated therewith. For each identified skill, an event-level rating is generated based on the contributed content, as indicated at block 506. The event-level rating can be generated based on content scores, such as an outcome score, a context score, and a sentiment score. At block 508, for a particular skill, the event-level rating can be aggregated with one or more other event-level ratings corresponding with the skill to generate a contributor rating associated with the skill. At block 510, the contributor rating associated with the skill can be provided, for example, to a user device, for display of the contributor rating.

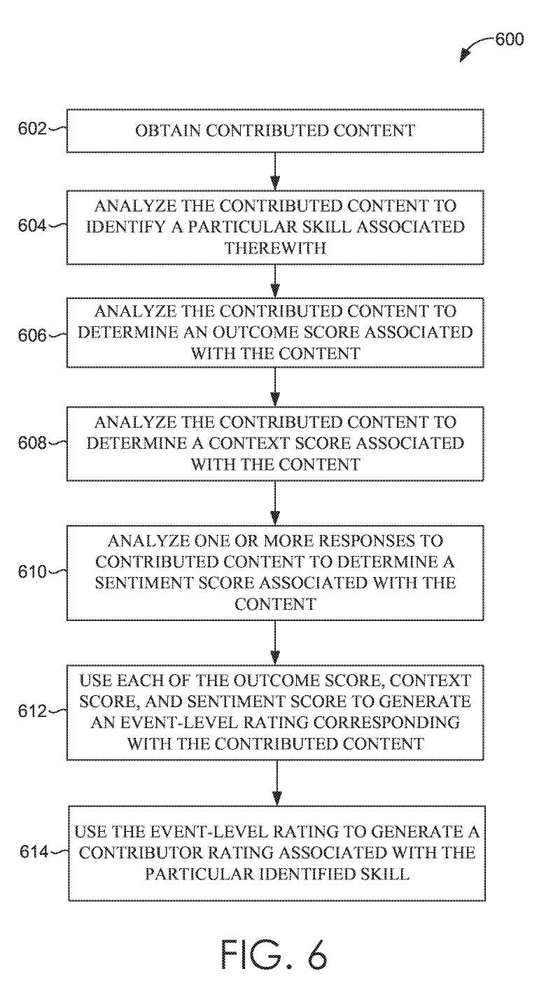

With reference to FIG. 6, a flow chart is illustrated showing an exemplary method 600 of generating contributor ratings, in accordance with embodiments of the present invention. In embodiments, the method 600 is performed by a contributor rating engine, such as contributor rating engine 200 of FIG. 2. Initially, and as indicated at block 602, contributed content is obtained. For example, contributed content may be provided by a contributor in response to a question posted by another user of a social networking platform. At block 604, the contributed content is analyzed to identify a particular skill associated therewith. At block 606, the contributed content is analyzed to determine an outcome score associated with the content. At block 608, the contributed content is analyzed to determine a context score associated with the content. At block 610, one or more responses to contributed content is analyzed to determine a sentiment score associated with the content. Each of the outcome score, context score, and sentiment score is used to generate an event-level rating corresponding with the contributed content. This is indicated at block 612. At block 614, the event-level rating is used to generate a contributor rating associated with the particular identified skill.

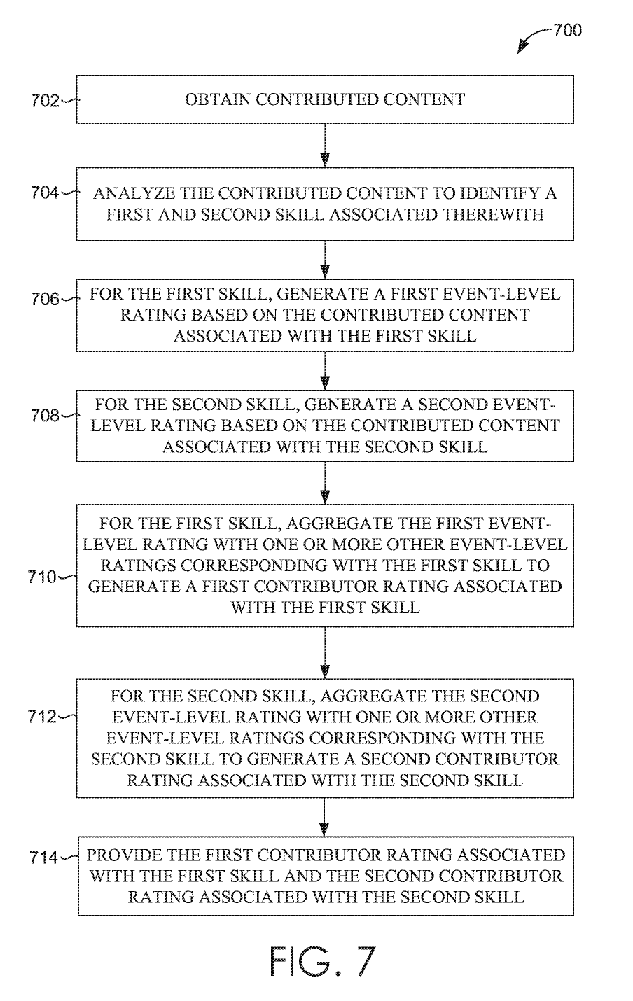

With reference now to FIG. 7, a flow diagram shows a method 700 of generating contributor ratings, in accordance with embodiments of the present invention. In embodiments, the method 700 is performed by a contributor rating engine, such as contributor rating engine 200 of FIG. 2. Initially, and as indicated at block 702, contributed content is obtained. For example, contributed content may be provided by a contributor in response to a question posted by another user of a social networking platform. At block 704, the contributed content is analyzed to identify a first and second skill associated therewith. For the first skill, a first event-level rating is generated based on the contributed content associated with the first skill, as indicated at block 706. For the second skill, a second event-level rating is generated based on the contributed content associated with the second skill, as indicted at block 708. The event-level ratings can be generated based on content scores, such as an outcome score, a context score, and a sentiment score. At block 710, for the first skill, the first event-level rating can be aggregated with one or more other event-level ratings corresponding with the first skill to generate a first contributor rating associated with the first skill. At block 712, for the second skill, the second event-level rating can be aggregated with one or more other event-level ratings corresponding with the second skill to generate a second contributor rating associated with the second skill. At block 714, the first contributor rating associated with the first skill and the second contributor rating associated with the second skill can be provided, for example, to a user device, for display of the contributor ratings.

Having described embodiments of the present invention, an exemplary operating environment in which embodiments of the present invention may be implemented is described below in order to provide a general context for various aspects of the present invention. Referring initially to FIG. 8 in particular, an exemplary operating environment for implementing embodiments of the present invention is shown and designated generally as computing device 800. Computing device 800 is but one example of a suitable computing environment and is not intended to suggest any limitation as to the scope of use or functionality of the invention. Neither should the computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes a bus 810 that directly or indirectly couples the following devices: memory 812, one or more processors 814, one or more presentation components 816, input/output (I/O) ports 818, input/output components 820, and an illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 8 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer-storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or 1/0 components 820. Presentation component(s) 816 present data indications to a user or other device. Exemplary presentation components include a display device, speaker, printing component, vibrating component, etc.

I/O ports 818 allow computing device 900 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be equipped with depth cameras, such as stereoscopic camera systems, infrared camera systems, RGB camera systems, touchscreen technology, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations comprising:
obtaining content contributed by a contributor in response to an inquiry posted via an online forum;
automatically identifying a first skill and a second skill associated with the contributed content using a domain-specific lexicon stored in a data store;
generating a first contributor rating for the first skill based on an automated analysis of at least a portion of the contributed content related to the first skill, the first contributor rating indicating a first value of the content contributed by the contributor in relation to the first skill;
generating a second contributor rating for the second skill based on an automated analysis of at least a portion of the contributed content related to the second skill, the second contributor rating indicating a second value of the content contributed by the contributor in relation to the second skill; and
providing at least one of the first contributor rating for the first skill and the second contributor rating for the second skill for presentation in association with the content contributed by the contributor.

2. The one or more computer storage media of claim 1, wherein the first skill comprises a first topic or subject matter and the second skill comprises a second topic or subject matter.

3. The one or more computer storage media of claim 1, wherein the first contributor rating for the first skill is generated by determining an event-level rating for the first skill based on the contributed content and aggregating the event-level rating with a set of additional event-level ratings determined for the first skill based on other content contributed by the contributor.

4. The one or more computer storage media of claim 3, wherein the second contributor rating for the second skill is generated by determining a second event-level rating for the second skill based on the contributed content and aggregating the second event-level rating with a second set of additional event-level ratings determined for the second skill based on the other content contributed by the contributor.

5. The one or more computer storage media of claim 3, wherein the event-level rating for the first skill is determined using at least one of an outcome score, a context score, and a sentiment score.

6. The one or more computer storage media of claim 3, wherein the event-level rating for the first skill is determined based on context and sentiment associated with the contributed content.

7. The one or more computer storage media of claim 6, wherein the sentiment is identified using one or more comments or feedback provided in response to the contributed content.

8. The one or more computer storage media of claim 1, wherein the first contributor rating and the second contributor rating are presented in association with the content contributed by the contributor.

9. The one or more computer storage media of claim 8, wherein the first skill is presented in association with the first contributor rating and the second skill is presented in association with the second contributor rating.

10. A computerized method to facilitate generation of contributor ratings, the method comprising:
obtaining content contributed by a contributor;
identifying a particular skill associated with the contributed content using a domain-specific lexicon within a data store;
determining an event-level rating indicating a value of the contributed content in relation to the particular skill, the event-level rating determined based on an automated analysis of the contributed content related to the particular skill to identify context and sentiment associated with the contributed content;
generating a contributor rating for the particular skill based on the event-level rating associated with the contributed content and a set of additional event-level ratings determined for the particular skill using other content contributed by the contributor; and
providing the contributor rating for the particular skill for presentation in association with the content contributed by the contributor.

11. The method of claim 10, wherein the particular skill comprises a particular topic or subject matter.

12. The method of claim 10, wherein the contributed content is provided by the contributor in response to a question posted via a social networking platform.

13. The method of claim 12, wherein the context associated with the contributed content is captured based on an extent the contributed content advances towards answering the question posted via the social networking platform.

14. The method of claim 12, wherein the sentiment associated with the contributed content is captured based on an extent of sentiment expressed in one or more comments or responses to the contributed content.

15. The method of claim 11, wherein the set of additional event-level ratings are weighted based on a time decay.

16. A computer system comprising:
an event-level rating generating means configured to generate event-level ratings for each skill identified in association with content contributed by a contributor; and
a contributor rating means configured to determine a set of contributor ratings for the contributor using the event-level ratings, wherein a contributor rating is determined for each identified skill to indicate a value of content provided by the contributed in relation to the corresponding skill.

17. The system of claim 16, wherein the event-level ratings are generated based on outcome scores, context scores, and sentiment scores.

18. The system of claim 16, wherein the skills identified comprise topics or subject matter.

19. The system of claim 16, wherein at least one contributor rating is provided for presentation in association with an indication of the contributor.

20. The system of claim 16 wherein the contributor rating for a particular skill comprises an aggregation of event-level ratings associated with the particular skill, the event-level ratings being weighted using an exponential decay across time.
